(19) United States
(12) Patent Application Publication
(10) Pub. No.: US 2024/0215500 A1
(43) Pub. Date: Jul. 4, 2024

(54) EXTENDABLE ARM FOR A CENTRE PIVOT IRRIGATION SYSTEM

(71) Applicant: Barend Christoffel BRITS, Durban, Kwa-Zulu Natal (ZA)

(72) Inventor: Barend Christoffel BRITS, Durban, Kwa-Zulu Natal (ZA)

(21) Appl. No.: 18/563,757

(22) PCT Filed: May 19, 2022
(86) PCT No.: PCT/IB2022/054661

§ 371 Date: Nov. 22, 2023

(30) Foreign Application Priority Data
May 24, 2021 (ZA) 2021/03488

(51) Int. Cl. A01G 25/09

(52) U.S. Cl. CPC A01G 25/092

(57) ABSTRACT

The invention provides an extendable arm (10) which is removably insertable into an irrigation pipeline (12) of a centre pivot irrigation system which includes a central tower and at least one movable tower for carrying the pipeline (12). The arm (10) comprises a first arm segment (14) which is connectable at one end thereof to the irrigation pipeline (12): a second arm segment (16) which is connectable at one thereof to the irrigation pipeline (12): and a connecting pipe (24) extending between the first and second arm segments (14, 16) to enable uninterrupted fluid flow in the irrigation pipeline (12). The first and second arm segments (14, 16) are displaceable relative to each other between a retracted and extended position to alternate radial distance between the movable tower and the central tower.

### BACKGROUND TO THE INVENTION

Irrigation systems have been used in the cultivation of crops for many years and is especially important to crop farmers in areas with little or unreliable rainfall. Centre pivot irrigation systems are well known for its precise water application to match crop requirements and soil characteristics, and therefore reduce water wastage. It may also reduce the amount of labour required for irrigating a specific field, since these systems are automated and can be operated by a single person, often times through a virtual connection.

A typical centre pivot irrigation system comprises a stationary central tower with a pivot mechanism and main control panel which is anchored to a small concrete base at a fixed water supply point (i.e., hydrant) at the center of a field; an irrigation pipeline of relatively large diameter, composed of high tensile galvanized light steel or aluminium pipes, radially extending from and rotatable about the central tower;

and a number of sequentially spaced moving towers for supporting the irrigation pipeline in an elevated position above ground, with the moving towers being able to move slowly over a planted field to irrigate the crops through sprinklers spaced at regular intervals along the pipeline.

Depending on its design, the length of a pipeline can vary from 50 m to 750 m. The pipeline is placed on wheeled A-frame towers of typically 3 m height above ground and spaced at 35 m-55 m distance apart (i.e., the length of a span), with the common length of spans being 40 m. Truss rod arches maintain an even distribution of weight and loads between the moving towers. The spans are equipped with flexible joints at the ends allowing the pipeline to articulate and to allow side-to-side, up-and-down, and rotational movement with no stress on the pipeline. The whole irrigation system rotates slowly, at a typical speed (i.e., of the last span) of 2-3 m/min around the central tower, applying water in the form of overhead spray irrigation and covers an irrigation area in a circular pattern. A drive system features small individual power units mounted on each wheeled tower. An automatic alignment system keeps the irrigating pipeline in straight alignment.

It will be appreciated that the wheels of the A-frame towers support a significant weight consisting of the tower frames, irrigation pipeline, sprinklers, and the water running through the irrigation pipeline. Due to the system being fixed at the central tower, the wheels of each tower run the same circular track with each rotation of the system, all whilst water from the sprinklers creates muddy conditions in the soil beneath. This continual running of the moving towers at a fixed radial distance from the central tower eventually causes the wheels to form ruts in the ground, causing the wheels to become stuck. This causes major problems and requires considerable labour and effort to release the wheels out of the mud, as evidenced by the different prior art, often very expensive, attempts to suggest solutions. Apart from the system becoming stuck, these ruts can cause significant damage to a particular field and repairing these ruts every season is costly and labour intensive.

The applicant aims to address the above-mentioned shortcomings of centre pivot irrigation systems by providing an extender for an irrigation pipeline which can lessen or prevent the formation of ruts by the wheels of the towers.

### SUMMARY OF THE INVENTION

According to the invention there is provided an extendable arm which is removably insertable into an irrigation pipeline of a centre pivot irrigation system which includes a central tower and at least one movable tower for carrying the pipeline, the arm comprising—
a first arm segment which is connectable at one end thereof to the irrigation pipeline;
a second arm segment which is connectable at one thereof to the irrigation pipeline,
with the first and second arm segments being displaceable relative to each other between a retracted and extended position to alternate radial distance between the movable tower and the central tower; and
a connecting pipe extending between the first and second arm segments to enable uninterrupted fluid flow in the irrigation pipeline.

The first arm segment may include a first irrigation pipe attachment for connecting the first arm segment at one thereof to the irrigation pipe; and at least two elongate first arms extending parallel to each other and from radially opposite positions from the first irrigation pipe attachment. The first arms may terminate at their free ends in first engagement formations for slidingly engaging the second arm segment. Each of the first arms may include at least one elongate channel extending substantially the length of the arms and located in inwardly facing faces of the first arms.

The second arm segment may include a second irrigation pipe attachment for connecting the second arm segment at one thereof to the irrigation pipe; and at least two elongate second arms extending parallel to each other and from radially opposite positions from the second irrigation pipe attachment. The second arms may terminate at their free ends in second engagement formations for slidingly engaging the first arms of the first arm segment. In one embodiment of the invention, the second arms may be arranged closer to each other compared to the distance between the first arms, such that the second arms fit between and slidingly engage the first arms. Each of the second arms may include at least one elongate channel extending substantially the length of the arms and located in outwardly facing faces of the second arms such that the channels of the second arms face the channels of the first arms.

The first and second arm segments may be displaceable relative to each other between an extended position, in which the first and second engagement formations are aligned; and a retracted position in which the second engagement formations press against the first irrigation pipe attachment, with the first engagement formations arranged approximate the second irrigation pipe attachment.

The first and second arms may be connected to each other through at least one connecting pin connected to either one of the first or second engagement formations and being slidable in the elongate channel of the other of the second or first arms, as the case may be. Particularly, in one embodiment of the invention, the connecting pins are connected to each of the first engagement formations of the first arms, extending inwardly and being slidable in the elongate channels of the second arms. In an alternative embodiment of the invention, the connecting pins are connected to each of the second engagement formations of the second arms, extending outwardly and being slidable in the elongate channels of the first arms. It will be appreciated that the engagement formations may include more than one connecting pin each. It will also be appreciated that the first and second arm segments may be slightly pivotable relative to each other at the connecting pin connection, thus allowing for a measure of flexibility over uneven ground conditions.

The connecting pipe may be a flexible pipe deformable to accommodate the extended and retracted positions of the first and second arm segments. The connecting pipe may be a concertina pipe. Alternatively, the extendable arm may include at least two connecting pipes of different lengths to accommodate the extended and retracted positions of the first and second arm segments respectively. The connecting pipe may terminate at each of its opposite ends in a pipe flange which is complimentarily configured for connecting the connecting pipe to the first and second irrigation pipe attachments respectively.

The extendable arm may include an adjustment mechanism to adjust the arm between the retracted and the extended configurations. The adjustment mechanism may comprise at least one elongate rod terminating in two opposite threaded ends, with one threaded end extending through the first irrigation pipe attachment and the second threaded end extending through the second irrigation pipe attachment; and two nuts for engaging the threaded rod ends for securing the threaded rod in place; the arrangement being such that rotation of the nuts on the threaded rod ends displaces the arm segments between the extended and retracted positions. In a preferred embodiment of the invention the extendable arm includes two threaded rods extending parallel to each other and penetrating at radially opposite positions through the first and second irrigation pipe attachments.

The extendable arm may include two intermediate pipe connectors for connecting the connecting pipe to the irrigation pipe attachments of the first and second arm segments respectively. Each intermediate pipe connector may terminate at opposite ends thereof in a radially extending connector flange dimensioned for connecting the pipe flanges to the second connector flanges, and for connecting the first connector flanges to the irrigation pipe attachments through a number of nuts and bolts extending through the various flanges. The irrigation pipeline may be connected to opposite sides of the irrigation pipe attachments, thus completing the fluid path of the extendable arm. The extendable arm may include a series of intermediate pipe connectors of different lengths to accommodate different connector pipe lengths intermediate the first and second arm segments.

According to a second aspect of the invention there is provided a centre pivot irrigation system, comprising—
a central tower; an irrigation pipeline extending from the central tower; and at least one moveable tower for carrying the pipeline; and
an extendable arm which is removably insertable into the irrigation pipeline and which comprises—
   a first arm segment which is connectable at one end thereof to the irrigation pipeline;
   a second arm segment which is connectable at one thereof to the irrigation pipeline, with the first and second arm segments being displaceable relative to each other between a retracted and extended position to alternate radial distance between the movable tower and the central tower; and
   a connecting pipe extending between the first and second arm segments to enable uninterrupted fluid flow in the irrigation pipeline.

### SPECIFIC EMBODIMENT OF THE INVENTION

Without limiting the scope thereof, the invention will now further be described and exemplified with reference to the accompanying drawings in which—

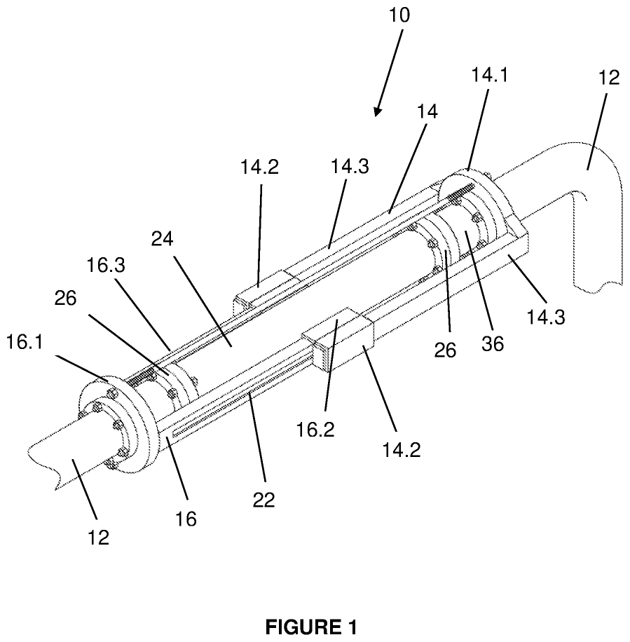

FIG. 1 is an assembled perspective view of an extendable arm according to the invention, in an extended configuration;

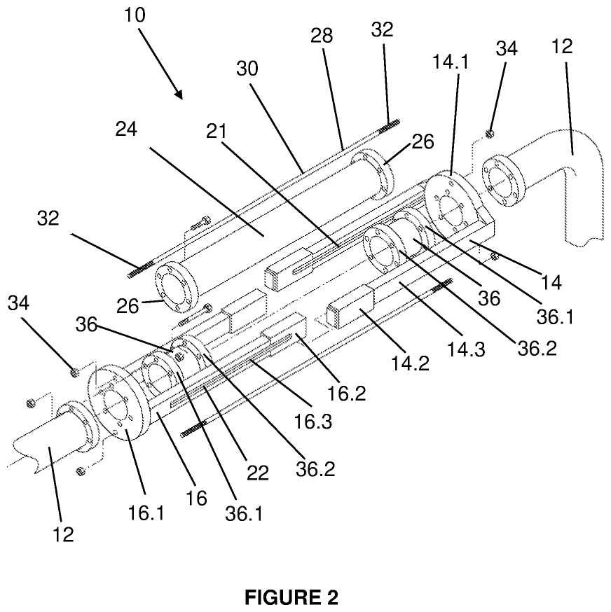

FIG. 2 is an exploded perspective view of the extendable arm of FIG. 1, illustrating construction of the arm;

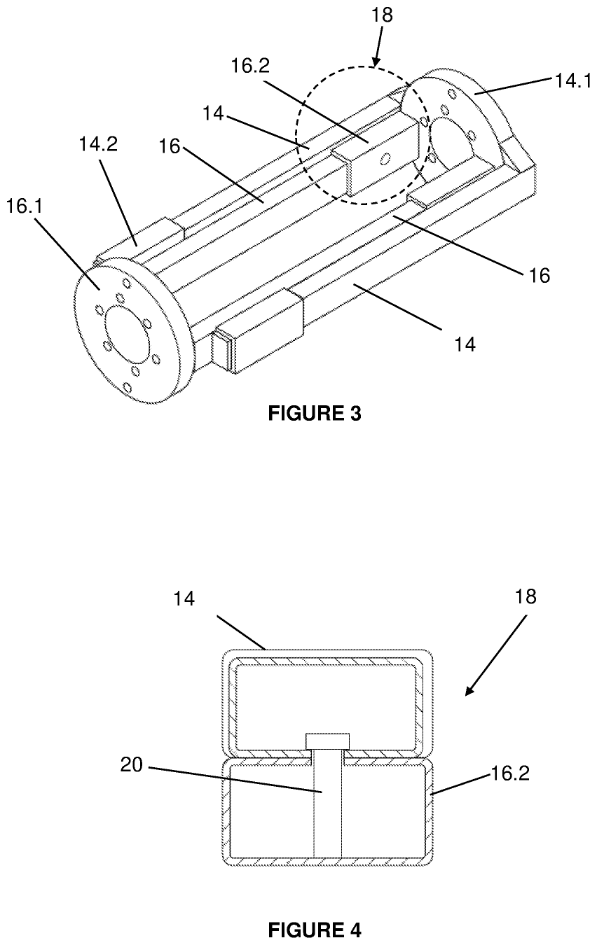

FIG. 3 is a perspective view of the first and second arm segments of the extendable arm in a retracted configuration;

FIG. 4 is a cross section of the engagement formation between the first and second arms;

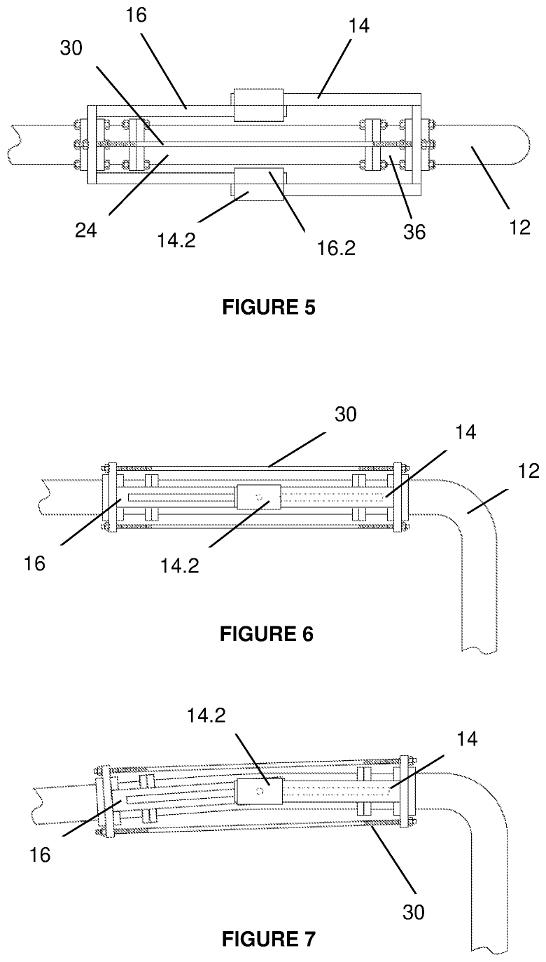

FIG. 5 is a plan view of the extendable arm in an extended position;

FIG. 6 is a side view of the extendable arm of FIG. 5; and

FIG. 7 is a side view of the extendable arm of FIG. 5, illustrating the slightly pivotable connection between the first and second arms.

The invention provides an extendable arm which is removably insertable into an irrigation pipeline of a centre pivot irrigation system (not shown). As provided for by the prior art, a centre pivot irrigation system includes a central tower (not shown),

an irrigation pipeline extending from the central tower, and at least one moveable tower (not shown) for carrying the pipeline [12].

The extendable arm of the invention comprises a first arm segment which is connectable at one end thereof to the irrigation pipeline [12]; a second arm segment

which is connectable at one thereof to the irrigation pipeline [12]; and a connecting pipe extending between the first and second arm segments [14; 16] to enable uninterrupted fluid flow in the irrigation pipeline [12]. The first and second arm segments [14; 16] are displaceable relative to each other between a retracted and extended position to alternate radial distance between the movable tower and the central tower.

The first arm segment includes a first irrigation pipe attachment [14.1] for connecting the first arm segment at one thereof to the irrigation pipe [12]. It also includes at least two elongate first arms [14.3] extending parallel to each other and from radially opposite positions from the first irrigation pipe attachment [14.1]. The first arms [14.3] terminate at their free ends in first engagement formations [14.2] for slidingly engaging the second arm segment [16]. Each of the first arms [14.3]includes at least one elongate channel extending substantially the length of the first arms [14.3] and located in inwardly facing faces of the first arms [14.3]. The second arm segment includes a second irrigation pipe attachment [16.1] for connecting the second arm segment at one thereof to the irrigation pipe [12]; and at least two elongate second arms [16.3] extending parallel to each other and from radially opposite positions from the second irrigation pipe attachment [16.1]. The second arms [16.3] terminate at their free ends in second engagement formations [16.2] for slidingly engaging the first arms [14.3] of the first arm segment [14]. In one embodiment of the invention, the second arms [16.3] are arranged closer to each other compared to the distance between the first arms [14.3], such that the second arms [16.3] fit between and slidingly engage the first arms [14.3]. Each of the second arms [16.3] include at least one elongate channel extending substantially the length of the arms [16.3] and located in outwardly facing faces of the second arms [16.3] such that the channels of the second arms [16.3] face the channels of the first arms [14.3].

The first and second arm segments [14; 16] are displaceable relative to each other between an extended position (refer FIG. 1), in which the first and second engagement formations [14.2; 16.2] are aligned; and a retracted position (refer FIG. 3) in which the second engagement formations [16.2] press against the first irrigation pipe attachment [14.1], with the first engagement formations [14.2] arranged approximate the second irrigation pipe attachment [16.1].

The first and second arms [14.3; 16.3] are connected to each other through at least one connecting pin connected to either one of the first or second engagement formations [14.2; 16.2] and being slidable on the elongate channel [21 or 22] of the other of the second or first arms [16.3; 14.3]. Particularly, in the illustrated embodiment of the invention, the connecting pins are connected to each of the second engagement formations [16.2] of the second arms [16.3], extending outwardly and being slidable in the elongate channels of the first arms [14.3]. As illustrated in FIG. 7, the first and second arm segments [14; 16] are slightly pivotable relative to each other at the connecting pin connection.

The connecting pipe is either a flexible pipe (for example a concertina pipe), which is deformable to accommodate the extended and retracted positions of the first and second arm segments [14; 16]; or the extendable arm includes at least two connecting pipes of different lengths to accommodate the extended and retracted positions of the first and second arm segments [14; 16] respectively. It will of course be appreciated that the extendable arm may include more than 2 connecting pipe lengths to provide for more than two positions. The connecting pipe terminates at each of its opposite ends in a pipe flange [26].

The extendable arm further includes two intermediate pipe connectors for connecting the connecting pipe to the irrigation pipe attachments [14.1; 16.1] of the first and second arm segments [14; 16] respectively. Each intermediate pipe connector terminates at opposite ends thereof in a radially extending connector flange [36.1; 36.2] dimensioned for connecting the pipe flanges to the second connector flanges [36.2], and for connecting the first connector flanges [36.1] to the irrigation pipe attachments [14.1; 16.1] through a number of nuts and bolts extending through the various flanges. The irrigation pipeline is connected to opposite sides of the irrigation pipe attachments [14.1; 16.1], thus completing the fluid path of the extendable arm [10].

The extendable arm includes an adjustment mechanism to adjust the arm between the retracted and the extended configurations. The adjustment mechanism comprises at least one elongate rod terminating in two opposite threaded ends [32], with one threaded end extending through the first irrigation pipe attachment [14.1] and the second threaded end extending through the second irrigation pipe attachment [16.1]; and two nuts for engaging the threaded rod ends for securing the threaded rod in place. Rotation of the nuts on the threaded rod ends displaces the arm segments [14; 16] between the extended and retracted positions. In a preferred embodiment of the invention the extendable arm includes two threaded rods extending parallel to each other and penetrating at radially opposite positions through the first and second irrigation pipe attachments [14.1; 16.1]. In the illustrated embodiment the adjustment mechanism is manually adjustable, but it will be appreciated that the first and second arm segments [14; 16] may be displaced relative to each other through automated means, such as hydraulic, electronic or robotic adjustment means.

It will be appreciated that other embodiments of the invention are possible without departing from the spirit or scope of the invention as set out in the claims.

1. An extendable arm that is removably insertable into an irrigation pipeline of a centre pivot irrigation system, which includes a central tower and at least one movable tower for carrying the pipeline, the arm comprising—
a first arm segment which is connectable at one end thereof to the irrigation pipeline;
a second arm segment which is connectable at one thereof to the irrigation pipeline,
with the first and second arm segments being displaceable relative to each other between a retracted and extended position to alternate radial distance between the movable tower and the central tower; and
a connecting pipe extending between the first and second arm segments to enable uninterrupted fluid flow in the irrigation pipeline.

2. The extendable arm according to claim 1 wherein the first arm segment includes a first irrigation pipe attachment for connecting the first arm segment at one thereof to the irrigation pipeline; and at least two elongate first arms extending parallel to each other and from radially opposite positions from the first irrigation pipe attachment.

3. The extendable arm according to claim 2 wherein the first arms terminate at their free ends in first engagement formations for slidingly engaging the second arm segment.

4. The extendable arm according to claim 3 wherein each of the first arms includes at least one elongate channel extending substantially the length of the arms and located in inwardly facing faces of the first arms.

5. The extendable arm according to claim 1 wherein the second arm segment includes a second irrigation pipe attachment for connecting the second arm segment at one thereof to the irrigation pipeline; and at least two elongate second arms extending parallel to each other and from radially opposite positions from the second irrigation pipe attachment.

6. The extendable arm according to claim 5 wherein the second arms terminate at their free ends in second engagement formations for slidingly engaging the first arm segment.

7. The extendable arm according to claim 6 wherein each of the second arms includes at least one elongate channel extending substantially the length of the arms and located in outwardly facing faces of the second arms.

8. The extendable arm according to claim 2 wherein the second arms of the second arm segment are arranged closer to each other compared to the distance between the first arms of the first arm segment, such that the second arms fit between and slidingly engage the first arms.

9. The extendable arm according to claim 4 wherein the channels of the second arms face the channels of the first arms.

10. The extendable arm according to claim 3 wherein the first and second arm segments are displaceable relative to each other between an extended position, in which the first and second engagement formations; are aligned; and a retracted position in which the second engagement formations press against the first irrigation pipe attachment, with the first engagement formations arranged approximate the second irrigation pipe attachment.

11. The extendable arm according to claim 4 wherein the first and second arms are connected to each other through at least one connecting pin connected to either one of the first or second engagement formations and being slidable in the elongate channel of the other of the second or first arms, as the case be.

12. The extendable arm according to claim 11 wherein the connecting pins are connected to each of the first engagement formations of the first arms, extending inwardly and being slidable in the elongate channels of the second arms.

13. The extendable arm according to claim 11 wherein the connecting pins are connected to each of the second engagement formations of the second arms, extending outwardly and being slidable in the elongate channels of the first arms.

14. The extendable arm according to claim 11 wherein the first and second arm segments are slightly pivotable relative to each other at the connecting pin connection, thus allowing for a measure of flexibility over uneven ground conditions.

15. The extendable arm according to claim 1 wherein the connecting pipe is a flexible pipe deformable to accommodate the extended and retracted positions of the first and second arm segments.

16. The extendable arm according to claim 15 wherein the connecting pipe is a concertina pipe.

17. The extendable arm according to claim 1 wherein the extendable arm includes at least two connecting pipes of different lengths to accommodate the extended and retracted positions of the first and second arm segments respectively.

18. The extendable arm according to claim 1 wherein the connecting pipe terminates at each of its opposite ends in a pipe flange which is complimentarily configured for connecting the connecting pipe to the first and second arm segments respectively.

19. The extendable arm according to claim 1 wherein the extendable arm includes an adjustment mechanism to adjust the arm between the retracted and the extended configurations.

20. The extendable arm according to claim 2 wherein the adjustment mechanism comprises at least one elongate rod terminating in two opposite threaded ends, with one threaded end extending through the first irrigation pipe attachment and the second threaded end extending through the second irrigation pipe attachment; and two nuts for engaging the threaded rod ends for securing the threaded rod in place; the arrangement being such that rotation of the nuts on the threaded rod ends displaces the arm segments between the extended and retracted positions.

21. The extendable arm according to claim 20 wherein the extendable arm includes two threaded rods extending parallel to each other and penetrating at radially opposite positions through the first and second irrigation pipe attachments.

22. The extendable arm according to claim 1 wherein the extendable arm includes two intermediate pipe connectors for connecting the connecting pipe to the first and second arm segments respectively, with the irrigation pipeline being connected to opposite sides of the first and second arm segments respectively, thus completing the fluid path of the extendable arm.

23. The extendable arm according to claim 22 wherein the extendable arm includes a series of intermediate pipe connectors of different lengths to accommodate different connector pipe lengths intermediate the first and second arm segments.

24. An extendable arm according to claim 1 wherein the adjustment mechanism is a hydraulic, electronic, or robotic adjustment means for automated displacement of the first and second arm segments relative to each other.

25. A centre pivot irrigation system, comprising
a central tower; an irrigation pipeline extending from the central tower; and at least one moveable tower for carrying the pipeline; and
an extendable arm which is removably insertable into the irrigation pipeline and which comprises
a first arm segment which is connectable at one end thereof to the irrigation pipeline;
a second arm segment which is connectable at one thereof to the irrigation pipeline, with the first and second arm segments being displaceable relative to each other between a retracted and extended position to alternate radial distance between the movable tower and the central tower; and
a connecting pipe extending between the first and second arm segments to enable uninterrupted fluid flow in the irrigation pipeline.

26. An extendable arm according to claim 1, substantially as herein illustrated and exemplified with reference to the accompanying Figures.
